(19) United States
(12) Patent Application Publication
(10) Pub. No.: US 2025/0142572 A1
(43) Pub. Date: May 1, 2025

(54) METHOD FOR DETERMINING RESOURCE OCCUPANCY IN MOBILE COMMUNICATION NETWORK AND APPARATUS FOR THE SAME

(71) Applicant: ELECTRONICS AND TELECOMMUNICATIONS RESEARCH INSTITUTE, Daejeon (KR)

(72) Inventors: Kyung Yul CHEON, Daejeon (KR); Hye Yeon KWON, Daejeon (KR); Kyung Won KIM, Daejeon (KR); Seung Keun PARK, Daejeon (KR); Eun Sook JIN, Daejeon (KR)

(21) Appl. No.: 18/930,074

(22) Filed: Oct. 29, 2024

(30) Foreign Application Priority Data
Oct. 30, 2023 (KR) 10-2023-0147249
Sep. 4, 2024 (KR) 10-2024-0119710

(51) Int. Cl. H04W 72/20; H04B 17/318; H04L 5/00; H04W 56/00; H04W 72/1273

(52) U.S. Cl. CPC H04W 72/20; H04B 17/328; H04L 5/0051; H04W 56/0015; H04W 72/1273

(57) ABSTRACT

The present disclosure relates to a method for determining whether a resource is occupied in a mobile communication system and a device therefor. A method for determining a resource occupancy in a mobile communication network according to an embodiment of the present disclosure may include calculating an occupancy threshold value based on received power for a transmission-limited resource; and based on a reference signal correlation power value for a specific resource block and the occupancy threshold value, determining whether the specific resource block is occupied.

### CROSS-REFERENCE TO RELATED APPLICATIONS

This application claims the benefit of earlier filing date and right of priority to Korean Patent Application No. 10-2023-0147249, filed on Oct. 30, 2023, and Korean Patent Application No. 10-2024-0119710, filed on Sep. 4, 2024, the contents of which are all hereby incorporated by reference herein in their entirety.

### TECHNICAL FIELD

The present disclosure relates to a mobile communication system, and in more detail, relates to a method for determining whether a resource is occupied and a device therefor.

### BACKGROUND ART

In order to operate a mobile communication network efficiently, it is required to measure the network load state of a network node (e.g., a base station or a cell) unit (i.e., all terminals accessing a network node), not a terminal unit. The network load may include a frequency utilization rate which is the rate of frequency resources used among all available frequency resources.

A frequency utilization rate measurement may be performed by analyzing scheduling information provided by a network node to terminals or by measuring received power for a frequency resource allocated by a network node. However, in the existing method for measuring a frequency utilization rate of the 5th generation (5G) mobile communication, a method for analyzing the scheduling information of a control channel is not provided, and in a method for measuring received power, a threshold value for determining whether a frequency resource is occupied is not defined, and a method for distinguishing whether it is occupied by an adjacent network node is also not defined. Accordingly, an improved method is required for more accurately and efficiently determining whether a resource used for measuring a frequency utilization rate is occupied.

### SUMMARY

The present disclosure is to provide a method for measuring a frequency utilization rate based on determining whether a resource is occupied and a device therefor.

The present disclosure is to provide a method for measuring a frequency utilization rate of a specific network node based on determining whether a resource is occupied by a specific network node and a device therefor.

The technical objects to be achieved by the present disclosure are not limited to the above-described technical objects, and other technical objects which are not described herein will be clearly understood by those skilled in the pertinent art from the following description.

A method for determining resource occupancy in a mobile communication network according to an embodiment of the present disclosure may include calculating an occupancy threshold value based on received power for a transmission-limited resource; and based on a reference signal correlation power value for a specific resource block and the occupancy threshold value, determining whether the specific resource block is occupied.

A device for determining resource occupancy in a mobile communication network according to an additional embodiment of the present disclosure may include at least one transceiver; at least one processor; and at least one memory operably connected to the at least one processor and storing an instruction that makes the device perform an operation when executed by the at least one processor. The processor may be configured to calculate an occupancy threshold value based on received power for a transmission-limited resource; and based on a reference signal correlation power value for a specific resource block and the occupancy threshold value, determining whether the specific resource block is occupied.

In some embodiments of the present disclosure, the occupancy threshold value may be calculated based on the maximum thermal noise power value for the transmission-limited resource.

In some embodiments of the present disclosure, the maximum thermal noise power value may be calculated by reflecting a thermal noise variation according to an ambient temperature for thermal noise collected for the transmission-limited resource.

In some embodiments of the present disclosure, the transmission-limited resource may correspond to a resource excluding a synchronization signal (SS), a primary synchronization signal (PSS) within a physical broadcast channel (PBCH) block (SSB), a secondary synchronization signal (SSS), and the PBCH.

In some embodiments of the present disclosure, the reference signal correlation power value may be calculated based on the power of the sum of signals multiplied by a complex conjugate of the reference signal sequence for a signal received at a candidate position of the reference signal in the specific resource block.

In some embodiments of the present disclosure, when the reference signal correlation power value for the specific resource block exceeds the occupancy threshold value, the specific resource block may be determined as being occupied. Alternatively, when the reference signal correlation power value for the specific resource block is less than or equal to the occupancy threshold value, the specific resource block may be determined as being unoccupied.

In some embodiments of the present disclosure, the specific resource block may include at least one physical resource block (PRB) on one orthogonal frequency division multiplexing (OFDM) symbol. In addition, the reference signal may be a demodulation reference signal (DMRS) for a physical downlink shared channel (PDSCH).

In some embodiments of the present disclosure, a frequency utilization rate may be calculated based on a result of the occupancy determination for each of at least one resource block within an available frequency resource.

In some embodiments of the present disclosure, the method may further include calculating a specific cell occupancy threshold value based on a first reference signal correlation power difference based on an unused cell-related identifier for the specific resource block determined as being occupied; calculating a second reference signal correlation power difference based on a specific cell-related identifier for the specific resource block determined as being occupied; determining whether the specific resource block determined as being occupied is occupied by the specific cell based on the second reference signal correlation power difference and the specific cell occupancy threshold value; and calculating a frequency utilization rate for the specific cell based on a result of determining whether each of at least one resource block within an available frequency resource is occupied by the specific cell.

A method for determining resource occupancy by a specific cell in a mobile communication network according to an additional embodiment of the present disclosure may include calculating a specific cell occupancy threshold value based on a first reference signal correlation power difference based on an unused cell-related identifier for a specific resource block; calculating a second reference signal correlation power difference based on a specific cell-related identifier for the specific resource block; and determining whether the specific resource block is occupied by the specific cell based on the second reference signal correlation power difference and the specific cell occupancy threshold value.

A device for determining resource occupancy by a specific cell in a mobile communication network according to an additional embodiment of the present disclosure may include at least one transceiver; at least one processor; and at least one memory operably connected to the at least one processor and storing an instruction that makes the device perform an operation when executed by the at least one processor. The processor may calculate a specific cell occupancy threshold value based on a first reference signal correlation power difference based on an unused cell-related identifier for a specific resource block; calculating a second reference signal correlation power difference based on a specific cell-related identifier for the specific resource block; and determining whether the specific resource block is occupied by the specific cell based on the second reference signal correlation power difference and the specific cell occupancy threshold value.

In some embodiments of the present disclosure, the first reference signal correlation power difference may be calculated based on a difference value between the average power value of a correlation signal of a first reference signal calculated by applying the unused cell-related identifier and a first reference signal correlation power value. In addition, for the distribution of the first reference signal correlation power difference, the specific cell occupancy threshold value may be calculated based on a confidence interval or an error rate.

In some embodiments of the present disclosure, the second reference signal correlation power difference may be calculated based on a difference value between the average power value of a correlation signal of a second reference signal calculated by applying the specific cell-related identifier and a second reference signal correlation power value.

In some embodiments of the present disclosure, when the specific resource block belongs to a plurality of resource blocks of a resource block group, a second reference signal correlation power difference for each of the plurality of resource blocks may be calculated; the average value of a plurality of second reference signal correlation power differences for the plurality of resource blocks may be calculated; and based on the average value of the plurality of second reference signal correlation power differences and the specific cell occupancy threshold value, whether the resource block group is occupied by the specific cell may be determined.

In some embodiments of the present disclosure, the unused cell-related identifier may have a value other than 0 to 1007.

In some embodiments of the present disclosure, the specific cell-related identifier may include at least one of a physical cell identifier (PCI) allocated to the specific cell or a scrambling identifier allocated to the specific cell. In addition, a PCI allocated to the specific cell may have a value of one of 0 to 1007.

In some embodiments of the present disclosure, when the second reference signal correlation power difference exceeds the specific cell occupancy threshold value, the specific resource block may be determined as not being occupied by the specific cell. Alternatively, when the second reference signal correlation power difference is less than or equal to the specific cell occupancy threshold value, the specific resource block may be determined as being occupied by the specific cell.

In some embodiments of the present disclosure, a frequency utilization rate for the specific cell may be calculated based on a result of determining whether each of at least one resource block within an available frequency resource is occupied by the specific cell.

In some embodiments of the present disclosure, the specific resource block may correspond to a resource block determined as being occupied because a reference signal correlation power value for the specific resource block exceeds an occupancy threshold value calculated based on received power for a transmission-limited resource.

The features briefly summarized above for the present disclosure are just an exemplary aspect of the detailed description of the present disclosure described below, and do not limit the scope of the present disclosure.

According to the present disclosure, a method and a device for measuring a frequency utilization rate based on determining whether a resource is occupied may be provided.

According to the present disclosure, a method and a device for measuring a frequency utilization rate of a specific network node based on determining whether a resource is occupied by a specific network node may be provided.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 is a diagram showing an example of a method for determining resource occupancy according to the present disclosure.

FIG. 2 is a diagram showing an example of a method for determining resource occupancy by a specific cell according to the present disclosure.

FIG. 3 is a diagram showing an example of a device for determining resource occupancy according to the present disclosure.

FIG. 4 is a diagram showing an example of a device for determining resource occupancy by a specific cell according to the present disclosure.

FIG. 5 is a diagram showing an example of calculating an occupancy threshold power value according to the present disclosure.

FIG. 6 is a diagram showing an example of a SSB structure including a transmission-limited resource according to the present disclosure.

FIG. 7A and FIG. 7B are diagrams showing examples for the resource mapping of a DMRS to which the present disclosure may be applied.

FIG. 8 is a diagram showing an example of calculating a DMRS sequence and correlation result according to the present disclosure.

FIG. 9 is a diagram showing an example of calculating a specific cell occupancy threshold value according to the present disclosure.

FIG. 10 is a diagram illustratively showing a 95% confidence level threshold value and a cumulative distribution function of a DMRS correlation power difference according to the present disclosure.

FIG. 11 is a diagram showing an example of a resource occupancy determination for measuring a frequency utilization rate according to the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

Hereinafter, various examples of the present disclosure for a method for determining resource occupancy in a mobile communication network are described.

In order to ensure the service performance and quality of a mobile communication network, a mobile communication service provider needs to measure a network load state such as traffic, a frequency utilization rate, etc. Equipment for monitoring a network load state may be generally classified into a base station scanner that measures information in a base station unit and a terminal diagnosis monitor that measures information in a terminal unit. In order to monitor network load at a base station scale, not in an individual terminal unit, a base station scanner capable of collecting information on all terminals connected to a base station is required.

In the existing 4th generation long-term evolution (LTE) mobile communication, traffic, a frequency utilization rate (e.g., a resource block (RB) utilization rate), etc. in a base station unit may be monitored by using a base station scanner capable of analyzing the downlink control information (DCI) of a physical downlink control channel (PDCCH). In the 5th generation (5G) new radio (NR) mobile communication, since a bandwidth part (BWP), a control resource set (CORESET) position, etc. may be configured differently for each terminal, it is difficult to analyze DCI without operating environment information, so it is hard to apply monitoring in a base station unit based on DCI analysis.

Meanwhile, as a frequency utilization rate measurement method for measuring a wireless resource allocated by a base station based on received power without analyzing DCI, there is a method for detecting a demodulation reference signal (DMRS) of a physical downlink shared channel (PDSCH) transmitted from a resource block (RB) allocated by a 5G base station. In this method, a candidate resource position where a DRMS may be positioned (e.g., an orthogonal frequency division multiplexing (OFDM) symbol and a resource element (RE)) may be monitored to calculate correlation power by a DMRS sequence, determining whether it is occupied.

In this occupancy determination method using correlation power, a method for calculating a threshold value for occupancy determination is not defined. In addition, a wireless resource may be occupied by a base station (or a cell) to be measured or a surrounding adjacent base station (or cell), but a method for distinguishing occupied wireless resources by base station identifier (or physical cell identifier (PCI)), i.e., a method for distinguishing wireless resources occupied by a base station (or a cell) to be measured among the occupied wireless resources and measuring a frequency utilization rate of a base station (or a cell) to be measured based thereon is not defined.

Generally, in a mobile communication network, one base station may be configured by including at least one cell distinguished by a physical cell identifier (PCI). A cell becomes a unit that manages its own wireless resource and reuses a wireless resource. In the following description, a method for determining resource occupancy is described by using a network corresponding to one cell as a representative example, but the embodiments of the present disclosure may be equally applied to a base station or another network node unit rather than a cell.

In the present disclosure, in order to measure the frequency utilization rate of 5G mobile communication or the next-generation mobile communication thereafter, a method is described in which an upper limit of power for non-occupancy is calculated to configure an occupancy threshold power value and it is compared with PDSCH DMRS correlation power to determine whether occupancy is performed. In addition, a method for configuring a specific cell occupancy threshold value for determining whether a designated cell is occupied and determining whether occupancy is performed by a specific cell is described. In this way, whether a resource is occupied by an arbitrary cell may be determined without distinguishing a cell and accordingly, a frequency utilization rate by an arbitrary cell may be measured. In addition, whether a resource is occupied by a specific cell may be determined and accordingly, a frequency utilization rate by a specific cell may be measured.

Hereinafter, the specific examples of a method and a device for calculating a wireless resource occupancy threshold value and a specific cell occupancy threshold value by using the statistical characteristics of a mobile communication measurement signal and calculating a frequency utilization rate by determining whether a wireless resource is occupied through this are described.

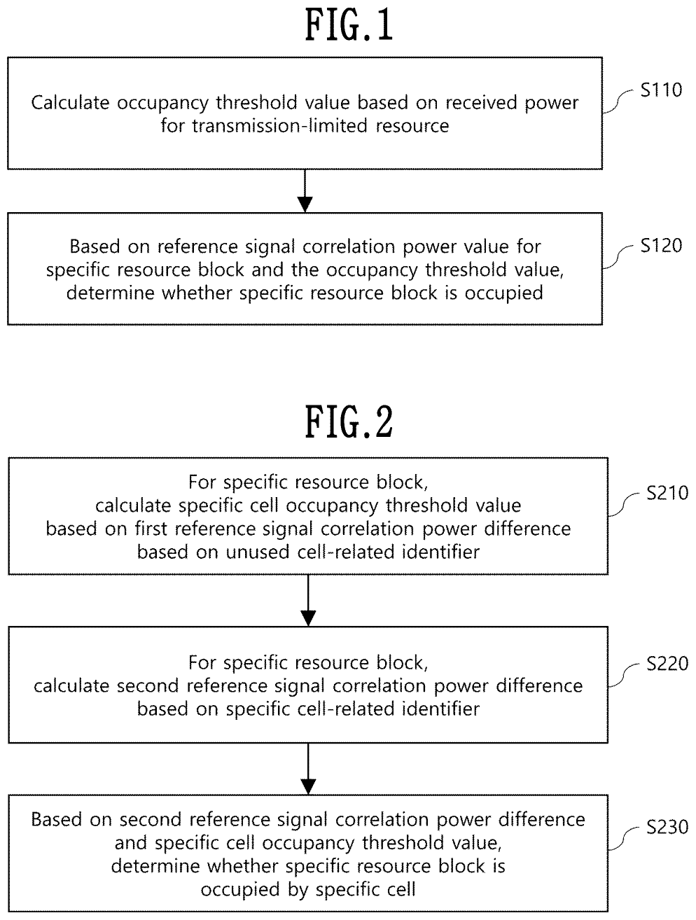

FIG. 1 is a diagram showing an example of a method for determining resource occupancy according to the present disclosure.

In S110, a device may calculate an occupancy threshold value based on received power for a transmission-limited resource.

An occupancy threshold value may be calculated based on the maximum thermal noise power value for a transmission-limited resource. Here, the maximum thermal noise power value may be calculated by reflecting a thermal noise variation according to ambient temperature for a thermal noise collected for a transmission-limited resource.

A transmission-limited resource may correspond to a resource excluding a synchronization signal (SS), a primary synchronization signal (PSS) within a physical broadcast channel (PBCH) block (SSB), a secondary synchronization signal (SSS), and the PBCH. In other words, a transmission-limited resource may correspond to a resource set to zero in a SSB as described below.

In S120, a device may determine whether a specific resource block is occupied based on a reference signal correlation power value for a specific resource block and an occupancy threshold value calculated in S110.

A reference signal correlation power value may be calculated based on the power of the sum of signals multiplied by the complex conjugate of a reference signal sequence for a signal received at a candidate position of a reference signal within a specific resource block. Here, the candidate position of a reference signal may refer to a resource position that is predefined to ensure that a corresponding reference signal is mapped when a corresponding reference signal is transmitted.

When a reference signal correlation power value for a specific resource block exceeds an occupancy threshold value (or is greater than or equal to an occupancy threshold value), a specific resource block may be determined as being occupied. Alternatively, when a reference signal correlation power value for a specific resource block is less than or equal to an occupancy threshold value (or is below an occupancy threshold value), a specific resource block may be determined as being unoccupied.

A specific resource block may include at least one physical resource block (PRB) on one OFDM symbol. Even when a reference signal is transmitted across a plurality of OFDM symbols, a reference signal correlation power value may be calculated on at least one PRB on one OFDM symbol and whether a resource is occupied may be determined based thereon.

For example, a reference signal may be a DMRS for a PDSCH. Alternatively, a reference signal may be a DMRS for another physical channel (e.g., a PDCCH, a PBCH, etc.).

A process of determining whether a specific resource block is occupied which is described by referring to FIG. 1 may be performed for each of at least one resource block within an available frequency resource (e.g., a system frequency domain configured for a cell). Based on a result of determining whether at least one resource block is occupied, a frequency utilization rate may be calculated.

A determination of whether occupancy is performed and the measurement of a frequency utilization rate in an example of FIG. 1 may relate to whether a corresponding resource block is occupied by arbitrary cell(s) and a frequency utilization rate by any cell(s) without distinguishing cells.

An example of FIG. 1 may be combined with an example of FIG. 2 described below. For example, for a specific resource block determined as being occupied according to an example of FIG. 1, whether it is occupied by a specific cell (e.g., a cell designated for measurement) may be additionally determined.

In this case, a device may calculate a specific cell occupancy threshold value based on a first reference signal correlation power difference based on an unused cell-related identifier (e.g., a ghost PCI) for a specific resource block determined as being occupied. In addition, a device may calculate a second reference signal correlation power difference based on a specific cell-related identifier for a specific resource block determined as being occupied. In addition, a device may determine whether a specific resource block determined as being occupied is occupied by a specific cell based on a second reference signal correlation power difference and a specific cell occupancy threshold value. In addition, a device may calculate a frequency utilization rate for a specific cell based on a result of determining whether each of at least one resource block within an available frequency resource is occupied by a specific cell.

Alternatively, a method of FIG. 2 may be performed independently from a method of FIG. 1. In other words, for a specific resource block whose occupancy is not determined, not a specific resource block determined as being occupied in an example of FIG. 1, whether a resource is occupied by a specific cell may be determined according to an example of FIG. 2.

FIG. 2 is a diagram showing an example of a method for determining resource occupancy by a specific cell according to the present disclosure.

In S210, a device may calculate a specific cell occupancy threshold value based on a first reference signal correlation power difference based on an unused cell-related identifier for a specific resource block.

A correlation power value for a reference signal may be calculated based on the power of a signal (i.e., a correlation signal for a reference signal) multiplied by a complex conjugate of a reference signal sequence for a signal received at a candidate position of a reference signal within a specific resource block, as described in an example of FIG. 1. It may correspond to a value (P_{c_avg} described below) obtained by dividing power for the sum of N_{D} correlation signals as a whole (i.e., power for one signal corresponding to the sum of N_{D} correlation signals) (P_{c_sum} described below) by N_{D}.

As a term distinct from a correlation power value for a reference signal, the average power value of a correlation signal for a reference signal in the present disclosure may correspond to average power (P_{d_avg}) obtained by dividing the sum of individual power values of N_{D} correlation signals (P_{d_sum} described below) by N_{D}.

A first reference signal correlation power difference may be calculated based on a difference value between the average power value of a correlation signal of a first reference signal calculated by applying an unused cell-related identifier and a first reference signal correlation power value. In addition, for the distribution of the first reference signal correlation power differences, a specific cell occupancy threshold value may be calculated based on a confidence interval or an error rate.

An unused cell-related identifier may have a value other than 0 to 1007. In other words, the range of actually usable PCI values is 0 to 1007, and an unused cell-related identifier may correspond to a PCI that is not definitely used (e.g., a value greater than or equal to 1008). A first reference signal correlation power difference based on an unused cell-related identifier may be calculated by applying the value of a PCI used for initializing a reference signal (e.g., a DMRS) as the value of an unused cell-related identifier.

In S220, a device may calculate a second reference signal correlation power difference based on a specific cell-related identifier for a specific resource block.

A second reference signal correlation power difference may be calculated based on a difference value between the average power value of a correlation signal of a second reference signal calculated by applying a specific cell-related identifier and a second reference signal correlation power value.

A specific cell-related identifier may be a PCI allocated to a specific cell and/or a scrambling identifier (e.g., nsC_{ID}) allocated to a specific cell. For example, a PCI allocated to a specific cell may have a value of one of 0 to 1007. A second reference signal correlation power difference based on a specific cell-related identifier may be calculated by applying the value of nsc_{ID} and/or a PCI used for initializing a reference signal (e.g., a DMRS) as the value of a specific cell-related identifier.

In S230, a device may determine whether a specific resource block is occupied by a specific cell based on a second reference signal correlation power difference and a specific cell occupancy threshold value.

A specific resource block may belong to a plurality of resource blocks of a resource block group (RBG). In this case, a second reference signal correlation power difference for each of a plurality of resource blocks may be calculated. In addition, the average value of the second reference signal correlation power differences for a plurality of resource blocks may be calculated. Accordingly, based on the average value of a plurality of second reference signal correlation power differences and a specific cell occupancy threshold value, whether a resource block group is occupied by a specific cell may be determined.

When a second reference signal correlation power difference exceeds a specific cell occupancy threshold value (or is equal to or greater than a specific cell occupancy threshold value), it may be determined that a specific resource block (or a specific resource block group) is not occupied by a specific cell. Alternatively, when a second reference signal correlation power difference is less than or equal to a specific cell occupancy threshold value (or is below a specific cell occupancy threshold value), it may be determined that a specific resource block (or a specific resource block group) is occupied by a specific cell.

A process of determining whether a specific resource block is occupied by a specific cell which is described by referring to FIG. 2 may be performed for each of at least one resource block within an available frequency resource (e.g., a system frequency domain configured for a cell). Based on a result of determining whether at least one resource block is occupied by a specific cell, a frequency utilization rate by a specific cell may be calculated.

A determination of whether occupancy is performed and the measurement of a frequency utilization rate in an example of FIG. 2 relates to a specific cell, and may be distinguished from a determination of whether occupancy is performed and the measurement of a frequency utilization rate by arbitrary cell(s) in an example of FIG. 1. In other words, an example of FIG. 2 may be performed in combination with FIG. 1 or may be performed independently.

For example, when an example of FIG. 2 is combined with an example of FIG. 1, a specific resource block that is a target of determining whether it is occupied by a specific cell in an example of FIG. 2 may correspond to a specific resource block determined as being occupied in an example of FIG. 1 (i.e., a reference signal correlation power value for a specific resource block exceeds an occupancy threshold value calculated based on received power for a transmission-limited resource).

Alternatively, a method of FIG. 2 may be performed independently from a method of FIG. 1. In other words, for a specific resource block whose occupancy is not determined, not a specific resource block determined as being occupied in an example of FIG. 1, whether a resource is occupied by a specific cell may be determined according to an example of FIG. 2.

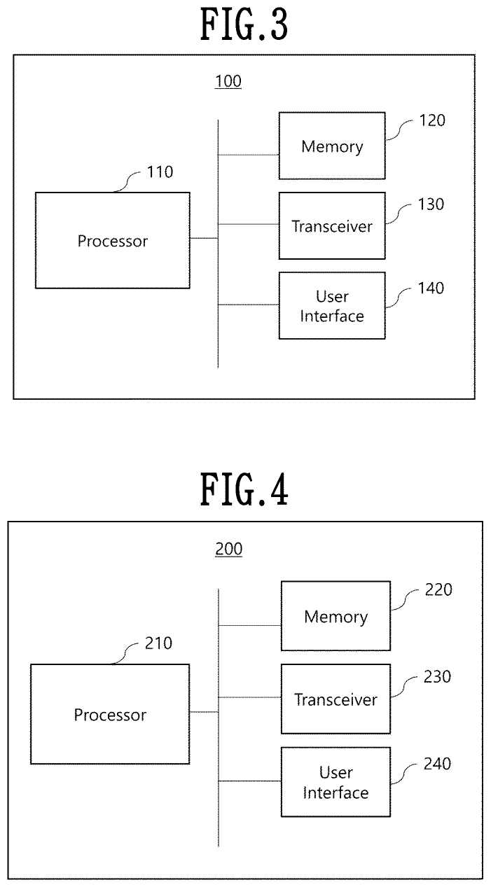

FIG. 3 is a diagram showing an example of a device for determining resource occupancy according to the present disclosure.

A device (100) may include at least one processor (110), at least one memory (120), at least one transceiver (130), at least one user interface (140), etc. A memory (120) may be included in a processor (110) or may be configured separately. A memory (120) may store an instruction that makes a device (100) perform an operation when executed by a processor (110). A transceiver (130) may transmit and/or receive a signal, data, etc. that is exchanged by a device (100) with another entity. A user interface (140) may receive a user's input for a device (100) or provide the output of a device (100) to a user. Among the components of a device (100), components other than a processor (110) and a memory (120) may not be included in some cases, and other components not shown in FIG. 3 may be included in a device (100).

A processor (110) may be configured to make a device (100) to perform an operation according to various examples of the present disclosure. Although not shown in FIG. 3, a processor (300) may be configured as a set of modules that perform each function. A module may be configured in the form of hardware and/or software. For example, a device (100) may correspond to a device for determining resource occupancy or a device for measuring a frequency utilization rate. A processor (110) may be configured to calculate an occupancy threshold value based on received power for a transmission-limited resource; and determine whether a specific resource block is occupied based on a reference signal correlation power value for a specific resource block and the occupancy threshold value. In addition, a processor (110) may be further configured to calculate a frequency utilization rate based on a result of determining whether each of at least one resource block within an available frequency resource is occupied.

For example, a processor (110) may include an occupancy threshold value calculation unit that calculates an occupancy threshold value based on received power for a transmission-limited resource; and an occupancy determination unit that determines whether a specific resource block is occupied based on a reference signal correlation power value for a specific resource block and the occupancy threshold value. In addition, a processor (110) may further include a frequency utilization rate calculation unit that calculates a frequency utilization rate based on a result of determining whether each of at least one resource block within an available frequency resource is occupied.

FIG. 4 is a diagram showing an example of a device for determining resource occupancy by a specific cell according to the present disclosure.

A device (200) may include at least one processor (210), at least one memory (220), at least one transceiver (230), at least one user interface (240), etc. A memory (220) may be included in a processor (210) or may be configured separately. A memory (220) may store an instruction that makes a device (200) to perform an operation when executed by a processor (210). A transceiver (230) may transmit and/or receive a signal, data, etc. that is exchanged by a device (200) with another entity. A user interface (240) may receive a user's input for a device (200) or provide the output of a device (200) to a user. Among the components of a device (200), components other than a processor (210) and a memory (220) may not be included in some cases, and other components not shown in FIG. 4 may be included in a device (200).

A processor (210) may be configured to make a device (200) to perform an operation according to various examples of the present disclosure. Although not shown in FIG. 4, a processor (300) may be configured as a set of modules that perform each function. A module may be configured in the form of hardware and/or software. For example, a device (200) may correspond to a device for determining whether a resource is occupied by a specific cell or a device for measuring a frequency utilization rate by a specific cell. A processor (210) may be configured to calculate a specific cell occupancy threshold value based on a first reference signal correlation power difference based on an unused cell-related identifier for a specific resource block; calculate a second reference signal correlation power difference based on a specific cell-related identifier for a specific resource block; and determine whether a specific resource block is occupied by a specific cell based on a second reference signal correlation power difference and a specific cell occupancy threshold value. In addition, a processor (210) may be further configured to calculate a frequency utilization rate for a specific cell based on a result of determining whether each of at least one resource block within an available frequency resource is occupied by a specific cell.

For example, a processor (210) may include a specific cell occupancy threshold value calculation unit that calculates a specific cell occupancy threshold value based on a first reference signal correlation power difference based on an unused cell-related identifier for a specific resource block; a second reference signal correlation power difference calculation unit that calculates a second reference signal correlation power difference based on a specific cell-related identifier for a specific resource block; and a specific cell occupancy determination unit that determines whether a specific resource block is occupied by a specific cell based on a second reference signal correlation power difference and a specific cell occupancy threshold value. In addition, a processor (210) may further include a specific cell frequency utilization rate calculation unit that calculates a frequency utilization rate for a specific cell based on a result of determining whether each of at least one resource block within an available frequency resource is occupied by a specific cell.

As described in a relationship between an examples of FIG. 1 and an example of FIG. 2, an example of FIG. 3 and an example of FIG. 4 may also be combined or applied independently. For example, at least one processor of one integrated device may include all sub-modules of a processor (110) in an example of FIG. 3 and a processor (210) in an example of FIG. 4. Alternatively, a device (100) of FIG. 3 and a device (200) of FIG. 4 may be implemented as a separate device.

Hereinafter, specific methods of the present disclosure for calculating a wireless resource occupancy threshold value and a specific cell occupancy threshold value by using the statistical characteristics of a measurement signal are described. A wireless resource occupancy threshold value refers to a threshold power value that determines whether a wireless resource (e.g., a RB) is occupied by an arbitrary unspecified base station/cell, and a specific cell occupancy threshold value refers to a threshold power value that determines whether a specific resource (e.g., a resource determined to be occupied) is occupied by a specific cell designated as a cell-related identifier (e.g., a PCI).

First, a method for calculating a wireless resource occupancy threshold power value is described.

In order to calculate a wireless resource occupancy threshold power value by an arbitrary base station/cell, a method for calculating the maximum value of unoccupied wireless resource power from signal power in a section where a resource is unoccupied may be used. In a mobile communication network, the beamforming technology using multiple transmitting antennas may be used to transmit a beam by designating a beam direction to a position of a specific terminal. Due to this beamforming technology, the reception intensity of an occupied wireless resource may be measured in various ways according to a beam direction at a position of a device for measuring a frequency utilization rate (or a device for determining resource occupancy). Accordingly, the distribution of reception intensity of an occupied resource may be very wide. However, a section where a resource is not occupied appears as a noise component, i.e., in the form of thermal noise that is changed only by temperature, so the dispersion of reception intensity distribution is small and shows a constant pattern. Accordingly, a method for calculating the maximum value of unoccupied reception intensity by using the distribution characteristics of this thermal noise may be used. In other words, since a signal higher than the maximum value of unoccupied reception intensity is determined to be occupied, this maximum value may be used as an occupied threshold power value.

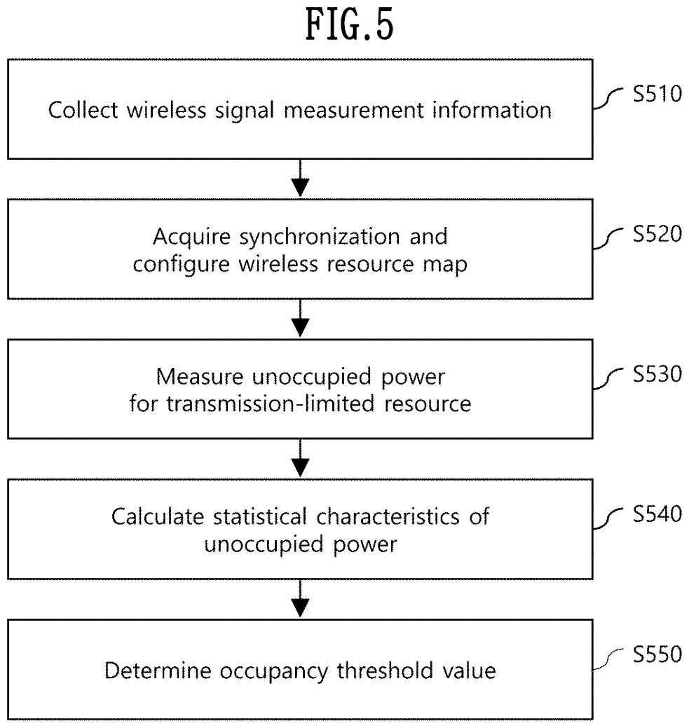

FIG. 5 is a diagram showing an example of calculating an occupancy threshold power value according to the present disclosure.

In S510, mobile communication wireless signal measurement information may be collected in an operating band (or an available frequency resource).

In S520, after obtaining synchronization using SSB search and extracting information such as a base station/cell identifier (e.g., a PCI), etc., a wireless resource map for each channel may be configured.

In S530, unoccupied power may be measured through the signal collection of a transmission-limited resource (or a transmission-prohibited region) which is a definite unoccupied section.

In S540, the statistical characteristics (e.g., distribution characteristics) of a measurement value for unoccupied power may be calculated.

In S550, an occupied threshold power value (or an occupied threshold value) may be determined based on the unoccupied power statistical characteristics.

Next, the calculation of characteristics of wireless resource unoccupied signal sample collection and distribution is described.

In order to calculate the maximum unoccupied reception intensity value, it is necessary to collect wireless signal samples in a section where non-occupancy is guaranteed. In 5G NR which is an exemplary mobile communication network system, a synchronization signal and a PBCH may be transmitted periodically (e.g., at a basic period of 20 ms or according to another period) in a SSB for the synchronization of a terminal.

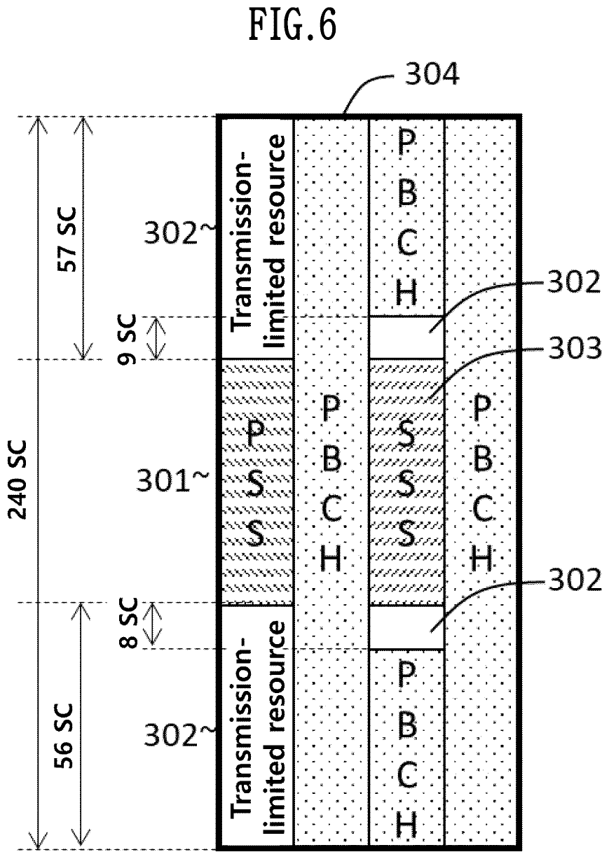

FIG. 6 is a diagram showing an example of a SSB structure including a transmission-limited resource according to the present disclosure.

In a NR system, a SSB includes a PSS region (301), a SSS region (303) and a PBCH region (304). A PSS and a SSS correspond to a synchronization signal used for synchronous reception and base station identifier recognition. A PBCH region (304) may include a master information block (MIB) for delivering basic information of a network such as a system frame number (SFN), etc. and a DMRS for a PBCH. In addition, a SSB may include a transmission-limited resource (302).

A transmission-limited resource (302) corresponds to a resource where transmission is not performed (i.e., a transmission-prohibited region), and may be set to zero. In the present disclosure, the signal measurement value of a transmission-limited resource (302) may be used for signal collection in a definite wireless resource unoccupied section. Table 1 shows an example of a resource mapping position within the SSB of a transmission-limited resource in a SSB.

TABLE 1

| | OFDM Symbol Number / | Subcarrier Number k |
|---|---|---|
| | (OFDM Symbol Index | (Subcarrier Index |
| Channel | relative to Time | relative to Frequency |
| or | Domain Start Point | Domain Start Point |
| Signal | of SSB) | of SSB) |
| Set to 0 | 0 | 0-55, 183-239 |
| | 2 | 48-55, 183-191 |

Referring to FIG. 5, a SSB may be composed of 4 OFDM symbols in a time domain (a horizontal axis in FIG. 5) and 240 subcarriers (SC) in a frequency domain (a vertical axis in FIG. 5). Here, a transmission-limited resource (302) is positioned at SC numbers 0-55 (i.e., 56 SCs) and SC numbers 183-239 (i.e., 57 SCs) in the first symbol (symbol number 0), and SC numbers 48-55 (i.e., 8 SCs) and SCs 183-191 (i.e., 9 SCs) in the third symbol (symbol number 2).

As described above, a transmission-limited resource corresponds to a region where signal transmission is prohibited. Generally, since the SSB of the same frequency is used in the same local cell of the same business operator, transmission is not performed even by an adjacent cell in a transmission-limited resource unlike other wireless resource regions. In other words, since a transmission-limited resource is guaranteed to be unoccupied even by an adjacent cell, like other wireless resources, a problem does not occur which wrongly collects thermal noise by misjudging a weak signal received from a serving cell or an adjacent cell as being unoccupied. Accordingly, since a transmission-limited resource is a section where only noise exists, the signal distribution of a noise section may be accurately estimated through signal collection in a transmission-limited resource. The collection of SSB signals may be performed through pre-measurement before a resource occupancy determination (or frequency utilization rate measurement) or parallel measurement during a resource occupancy determination (or frequency utilization rate measurement).

The distribution and threshold value characteristics of a noise signal collected on a transmission-limited resource within a SSB may be analyzed. Generally, it is known that a noise signal in a mobile communication system is a thermal noise signal generated inside a device and a thermal noise signal has a normal distribution with an average of 0 and a standard deviation of a constant value. When the real component of a signal collected from a transmission-limited resource is In-phase (I) and an imaginary component is Quadrature (Q), each of I and Q follow a normal distribution with an average of 0 and a standard deviation of a constant value σ, and in this case, received power P may be expressed as in Equation 1.

$$P = {I}^{2} + {Q}^{2} \qquad [ Equation 1 ]$$

Here, when the average of I and Q is μ_{I} and μ_{Q}, respectively and a standard deviation is σ_{I} and σ_{Q}, respectively, I and Q are normally distributed, so each is μ_{I}=0 and μ_{Q}=0 and a standard deviation at the same temperature is expressed as the same σ_{I}=σ_{Q}=σ, wherein Z_{I} and Zₒ which are a standard normalized variable of I and Q may be expressed as in Equation 2.

$${\begin{matrix}{Z}_{I} = \frac{I - {μ}_{I}}{{σ}_{I}} = \frac{1}{σ} , {Z}_{I} = \frac{I - {μ}_{Q}}{{σ}_{Q}} = \frac{Q}{σ} & [ Equation 2 ]\end{matrix}}_{}$$

Power P_{z} by Z_{I} and Z_{Q} may be expressed as in Equation 3.

$${P}_{Z} = {Z}_{I}^{2} + {Z}_{Q}^{2} = \frac{{I}^{2}}{{σ}^{2}} + \frac{{Q}^{2}}{{σ}^{2}} = \frac{P}{{σ}^{2}} \qquad [ Equation 3 ]$$

Statistically, it is known that the sum of squares of two standard normal distributions has a chi-square distribution with a freedom degree of 2.

Next, the calculation of thermal noise threshold power value in an unoccupied section is described.

Since the above-described standard normalized power P_{z}, i.e., P/σ² follows a chi-square distribution, an occupied threshold value (P_{th_0}) may be selected according to a confidence interval determined by using the characteristics of a chi-square distribution (e.g., a chi-square distribution table). For example, when a threshold value that satisfies a 95% confidence interval is designated, a target probability in a chi-square distribution table in Table 2 is 0.05 (=1-0.95), the upper limit of a distribution and a corresponding power value is 5.99 when a degree of freedom is 2, so it is z=P/σ²=5.99 and a threshold power value P=5.99×σ² becomes an occupied threshold value (P_{th_0}) in a 95% confidence interval. In other words, σ, a standard deviation of thermal noise, is determined by temperature at the time of measurement, so in the present disclosure, it is represented in a form that reflects a variation in the dispersion of thermal noise signals due to temperature. Accordingly, in the present disclosure, dispersion which is a statistical characteristic of thermal noise may be measured to calculate a threshold power value reflecting a variation in thermal noise due to temperature.

TABLE 2
Percentage Points of the Chi-Square Distribution

| Degrees of | Probability of a larger value of x² | | | | | | | | |
|---|---|---|---|---|---|---|---|---|---|
| Freedom | 0.99 | 0.95 | 0.90 | 0.75 | 0.50 | 0.25 | 0.10 | 0.05 | 0.01 |
| 1 | 0.000 | 0.004 | 0.016 | 0.102 | 0.455 | 1.32 | 2.71 | 3.84 | 6.63 |
| 2 | 0.020 | 0.103 | 0.211 | 0.575 | 3.386 | 2.77 | 4.61 | 5.99 | 9.21 |
| 3 | 0.115 | 0.352 | 0.584 | 1.212 | 2.366 | 4.11 | 6.25 | 7.81 | 11.34 |
| 4 | 0.297 | 0.711 | 1.064 | 1.923 | 3.357 | 5.39 | 7.78 | 9.49 | 13.28 |
| 5 | 0.554 | 1.145 | 1.610 | 2.675 | 4.351 | 6.63 | 9.24 | 11.07 | 15.09 |
| 6 | 0.872 | 1.635 | 2.204 | 3.455 | 5.348 | 7.84 | 10.64 | 12.59 | 16.81 |
| 7 | 1.239 | 2.167 | 2.833 | 4.255 | 6.346 | 9.04 | 12.02 | 14.07 | 18.48 |
| 8 | 1.647 | 2.733 | 3.490 | 5.071 | 7.344 | 10.22 | 13.36 | 15.51 | 20.09 |
| 9 | 2.088 | 3.325 | 4.168 | 5.899 | 8.343 | 11.39 | 14.68 | 16.92 | 21.67 |
| 10 | 2.558 | 3.940 | 4.865 | 6.737 | 9.342 | 12.55 | 15.99 | 18.31 | 23.21 |
| 11 | 3.053 | 4.575 | 5.578 | 7.584 | 10.341 | 13.70 | 17.28 | 19.68 | 24.72 |
| 12 | 3.571 | 5.226 | 6.304 | 8.438 | 11.340 | 14.85 | 18.55 | 21.03 | 26.22 |
| 13 | 4.107 | 5.892 | 7.042 | 9.299 | 12.340 | 15.98 | 19.81 | 22.36 | 27.69 |
| 14 | 4.660 | 6.571 | 7.790 | 10.165 | 13.339 | 17.12 | 21.06 | 23.68 | 29.14 |
| 15 | 5.229 | 7.261 | 8.547 | 11.037 | 14.339 | 18.25 | 22.31 | 25.00 | 30.58 |
| 16 | 5.812 | 7.962 | 9.312 | 11.912 | 15.338 | 19.37 | 23.54 | 26.30 | 32.00 |
| 17 | 6.408 | 8.672 | 10.085 | 12.792 | 16.338 | 20.49 | 24.77 | 27.59 | 33.41 |
| 18 | 7.015 | 9.390 | 10.865 | 13.675 | 17.338 | 21.60 | 25.99 | 28.87 | 34.80 |
| 19 | 7.633 | 10.117 | 11.651 | 14.562 | 18.338 | 22.72 | 27.20 | 30.14 | 36.19 |
| 20 | 8.260 | 10.851 | 12.443 | 15.452 | 19.337 | 23.83 | 28.41 | 31.41 | 37.57 |
| 22 | 9.542 | 12.338 | 14.041 | 17.240 | 21.337 | 26.04 | 30.81 | 33.92 | 40.29 |
| 24 | 10.856 | 13.848 | 15.659 | 19.037 | 23.337 | 28.24 | 33.20 | 36.42 | 42.98 |
| 26 | 12.198 | 15.379 | 17.292 | 20.843 | 25.336 | 30.43 | 35.56 | 38.89 | 45.64 |
| 28 | 13.565 | 16.928 | 18.939 | 22.657 | 27.336 | 32.62 | 37.92 | 41.34 | 48.28 |
| 30 | 14.953 | 18.493 | 20.599 | 24.478 | 29.336 | 34.80 | 40.26 | 43.77 | 50.89 |
| 40 | 22.164 | 26.509 | 29.051 | 33.660 | 39.335 | 45.62 | 51.80 | 55.76 | 63.69 |
| 50 | 27.707 | 34.764 | 37.689 | 42.942 | 49.335 | 56.33 | 63.17 | 67.50 | 76.15 |
| 60 | 37.485 | 43.188 | 46.459 | 52.294 | 59.335 | 66.98 | 74.40 | 79.08 | 88.38 |

Next, an occupancy determination using reference signal correlation power and occupied threshold power is described.

A PDSCH DMRS is described first as an example of a reference signal.

In a 5G NR mobile communication network system, a PDSCH DMRS is a signal transmitted only to a RB to which a PDSCH is allocated for channel estimation and demodulation of a PDSCH transmission signal, and is transmitted to a position determined in a RB (i.e., a DMRS candidate position). In other words, since a RB where a PDSCH DMRS exists is a RB occupied by a base station, whether a resource is occupied may be determined by determining whether a DMRS exists in a specific RB. Other details on a PDSCH DMRS follow a description in the 3rd Generation Partnership Project (3GPP) standard document.

A type of a PDSCH DMRS is divided into Type A and Type B according to a start symbol position in a time domain and is divided into Type 1 and Type 2 according to the position of a subcarrier in a frequency domain. For Type A, a DMRS may be positioned starting from the 3rd or 4th symbol among 14 symbols in one slot of one RB. For Type B, a DMRS may be positioned without a restriction on a start point from the 1st symbol in one slot of one RB. For Type 1, a DMRS may be positioned in 6 non-consecutive resource elements (RE) among 12 subcarriers of one symbol among the symbol(s) where a DMRS is positioned in a RB. For Type 2, since there are two RE pairs composed of two consecutive REs, a DMRS may be positioned in a total of 4 REs (or subcarriers) among 12 subcarriers of one symbol among the symbol(s) where a DMRS is positioned in a RB. For a double symbol DMRS, a DMRS may be positioned in up to two symbols in one slot of one RB, and a DMRS additional position for additional DMRS arrangement may be configured.

In order to determine whether a resource is occupied in the present disclosure, only whether a DMRS exists in a RB needs to be determined, so for the simplification of a procedure, whether a DMRS exists may be determined only for one symbol where a DMRS may be positioned.

In addition, a different DMRS must be used for each antenna port, and an antenna port may be distinguished based on a combination of a code value applied to a DMRS sequence and a DMRS position. For example, for a DMRS at the same symbol and subcarrier position, a DMRS for a different antenna port may be distinguished by a code division multiplexing (CDM) method.

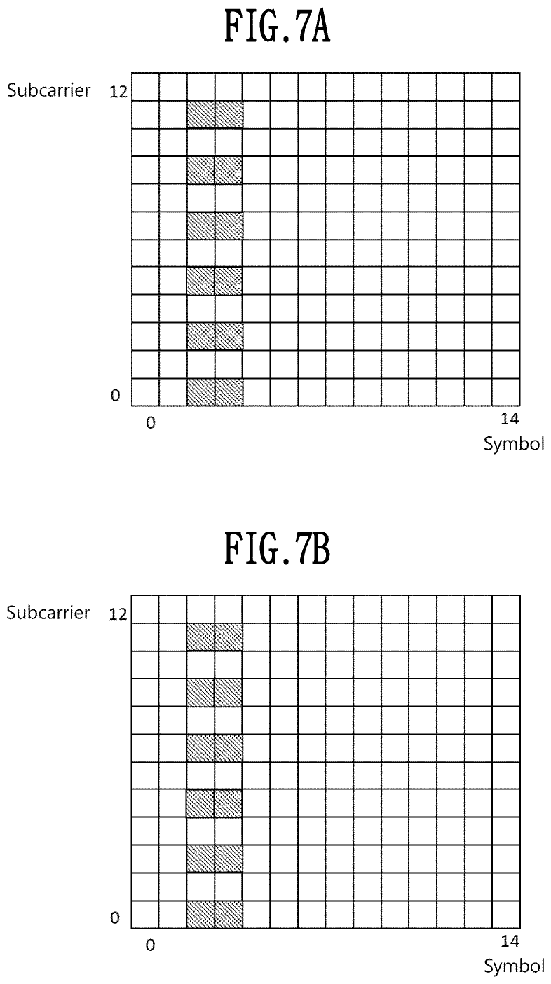

FIG. 7A and FIG. 7B are diagrams showing examples for the resource mapping of a DMRS to which the present disclosure may be applied.

For DMRS Type A, Port 1000, FIG. 7A shows an example of DMRS mapping according to Type 1 and a double symbol method, and FIG. 7B shows an example of DMRS mapping according to Type 2 and a double symbol method.

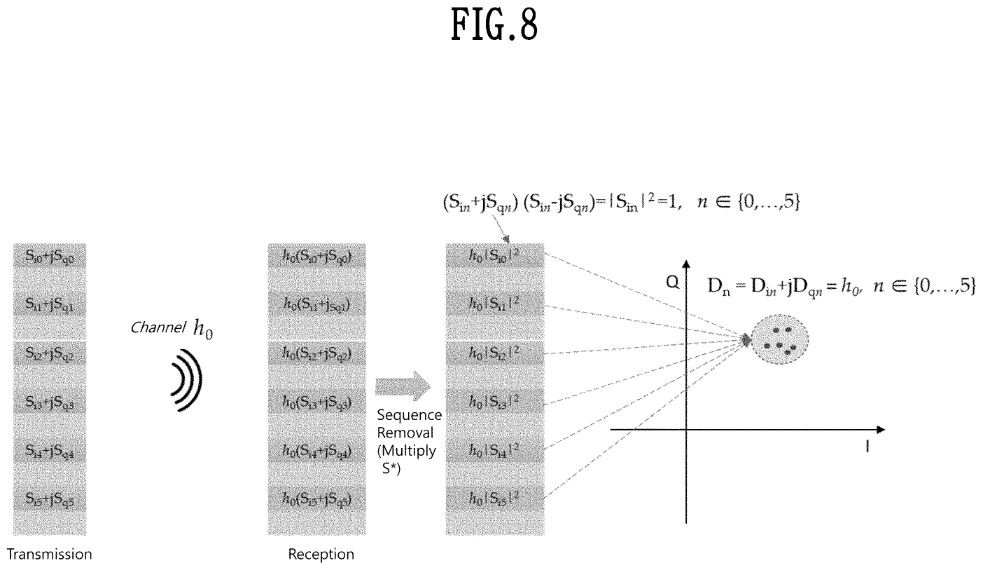

FIG. 8 is a diagram showing an example of calculating a DMRS sequence and correlation result according to the present disclosure.

In the present disclosure, a value obtained by multiplying a reception signal at a DMRS candidate position by a complex conjugate of a serving cell sequence is referred to as a DMRS correlation signal. In addition, power for the sum of DMRS correlation signals as a whole is referred to as DMRS correlation power. The sequence of a PDSCH DMRS may be generated by using unique information as an input value (or an initialization value) for each base station/cell such as a base station/cell identifier (PCI), etc. When correlation power based on the same sequence using the same basic information (e.g., the same base station/cell identifier) is calculated for a transmission signal (i.e., power for the sum of DMRS correlation signals obtained by multiplying a DMRS sequence by a complex conjugate is calculated), correlation power may be calculated as the same value of 1 for each DMRS mapping position if a channel effect is ignored. On the other hand, when DMRS correlation power is calculated based on a different sequence, it has a value of one of +1 and +j.

When a channel effect is considered, if a DMRS sequence is the same, a result value converges to the same/adjacent constellation points as in FIG. 8, whereas if a different sequence is used to calculate correlation power, some values have a different sign value, showing an effect in which the values of different signs offset the power of the sum.

With this, a PDSCH DMRS may generate a sequence as a unique identifier for each corresponding base station/cell to distinguish between a base station and a cell, and may distinguish cells by a combination of these sequences. For example, the generation of sequence s (n) used by a terminal may follow Equation 4.

$$s ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) \qquad [ Equation 4 ]$$

The initial value of pseudorandom sequence c (i) may be generated to ensure that a sequence may be distinguished for each base station by using a scrambling identifier (e.g., nsC_{ID}) transmitted from a base station/a cell to a terminal or a cell identifier (e.g., a PCI) when a scrambling identifier is not transmitted. A terminal may distinguish the DMRS of a serving cell from the DMRS of another adjacent cell through this. A DMRS correlation signal refers to a value obtained by removing a DMRS sequence allocated to a terminal from a DMRS reception signal (i.e., a value obtained by multiplying a complex conjugate of a sequence).

Referring to FIG. 8, an example is shown for a DMRS correlation signal obtained when calculated by using the same sequence when a transmitting side transmits a DMRS signal where N_{D} subcarriers/REs are mapped to one symbol (hereinafter, the number of DMRSs is expressed as N_{D}, and hereinafter, for convenience of a description, N_{D}=6 is assumed, but the following examples may also be applied to a case of a different number other than 6). When a DMRS transmission signal is Sₙ=Sᵢₙ+jS_{qn} (here, n={0, . . . ,5}), Sₙ has a value of one of four combinations of

$$\pm \frac{1}{\sqrt{2}} \pm j \frac{1}{\sqrt{2}}$$

in Equation 4, and this value is configured as a different value for each slot within a DMRS position, so it may be shown as a total of 4ⁿ combinations. In addition, since it may be assumed that a channel (h₀) is the same within the same RB, a signal at a DMRS position on a receiving side becomes h₀ (Sₙ+N) (here, N is thermal noise), and when a complex conjugate of a sequence (S*=Sᵢₙ−jS_{qn}) is multiplied to remove a sequence, Dₙ, a DMRS correlation signal, is shown as in Equation 5.

$${D}_{n} = ( {h}_{0} {S}_{n} + N ) \times {S}_{n} * {=}_{.}^{.} {h}_{0} {\vert {S}_{n} \vert}^{2} = {h}_{0} , ( if {S}_{n} >> N ) \qquad [ Equation 5 ]$$

In other words, when a signal to interference ratio (SINR) is high (i.e., Sₙ>>N), all of six DMRS correlation results are shown as h₀|Sₙ|², and are |Sₙ|²=1 due to the characteristic of a sequence, so channel function h₀ is finally left in the form of a complex number. Accordingly, when the same sequence is used, the sum of sequence-removed values becomes 6 times h₀ (6h₀), and six signals converge to one point (h₀, a complex number) on a constellation diagram. In fact, since noise and a channel function may be slightly different for each DMRS position in a RB, they appear to converge near one point as in FIG. 8. If there is a different sequence (S′ᵢₙ), a sequence removal result is Sᵢₙ×(S′ᵢₙ) * and is shown in the form of one of −1, +j or −j, not 1, so when results thereof are combined, it shows an effect in which power is offset compared to when a sequence removal result is 1 in the case of the same sequence. In particular, when a RB is not occupied and accordingly, is Sᵢₙ=0, and only thermal noise (N) exists at a corresponding DMRS position, DMRS correlation power is the same as thermal noise power as in Equation 6, so the distribution of thermal noise may be used as the distribution of DMRS correlation power.

$${\vert {D}_{n} \vert}^{2} = {\vert ( {h}_{0} {S}_{n} + N ) \times {S}_{n}^{′} * \vert}^{2} = {\vert N \times {S}_{n}^{′} \vert}^{2} = {\vert N \vert}^{2} , where {S}_{n} = 0 , \vert {S}_{n}^{′} \vert = 1 \qquad [ Equation 6 ]$$

In other words, when a received DMRS sequence is the same as the serving cell sequence of a terminal due to the characteristic of a sequence, signals multiplied by a serving cell sequence become the same value (the same point on a constellation diagram) and power for the sum of that DMRS correlation signals has the maximum power value as in FIG. 8, and when they are a different sequence, some are shown as a signal of a different value, so power for the sum of signals is reduced. The maximum DMRS correlation power value is determined according to the length of a sequence, and for example, when a sequence of 6 lengths is transmitted to one symbol, it has 6 times power gains when multiplying the same sequence (e.g., a serving cell sequence) and it has arbitrary power less than 6 times when multiplying a different sequence (e.g., an adjacent cell sequence). If only noise exists without a DMRS in a RE at a corresponding position, a DMRS correlation signal is randomly positioned on a constellation diagram to substantially offset the sum of correlation signals.

Next, a determination on whether a wireless resource is occupied is explained.

A value obtained by multiplying a reception signal at a DMRS position by the complex conjugate of a serving cell sequence is referred to as a DMRS correlation signal, and DMRS correlation power may be calculated based on power for the sum of these DMRS correlation signals. Here, when a DMRS correlation signal is Dₙ=Dᵢₙ+jD_{qn} (n is an index within the range of N_{D}, the number of DMRSs (i.e., n=0, 1, . . . , N_{D}−1)), the individual power of the n-th correlation signal Dₙ among the N_{D} correlation signals may be expressed as |Dₙ|². When the sum of individual power of DMRS correlation signals for all n values (i.e., 0, 1, . . . , N_{D}−1) is referred to as P_{d_sum}, it may be expressed as in Σₙ|Dₙ|², the left-hand side of Equation 7. Meanwhile, when the sum of DMRS correlation signals corresponds to one signal (i.e., Σₙ Dₙ) corresponding to the sum of N_{D} correlation signals and power for the sum of DMRS correlation signals is referred to as P_{c_sum}, it may be expressed as in |Σₙ Dₙ|², the right-hand side of Equation 7. Since it is known that a noise signal statistically has a normal distribution with an average of 0, the expected value of the sum of noise signals becomes 0, and when only a noise signal exists at a DMRS position (i.e., when Sₙ is 0 as in Equation 6), the sum of correlation signals Dₙ of noise is offset each other according to the characteristics of the Gaussian distribution and converges to 0 when n is sufficiently large. In other words, for a noise signal, the sum of each signal is offset to approach 0, so power for the sum of each signal becomes smaller than the sum of each signal power.

Equation 7 expresses the inequality of power between the sum of individual power of n (=0, 1, . . . , Np-1)-th correlation signals and the sum of DMRS correlation signals when only a noise signal is received.

$${\sum }_{n} {\vert {D}_{n} \vert}^{2} \geq {\vert {\sum }_{n} {D}_{n} \vert}^{2} \qquad [ Equation 7 ]$$

Accordingly, when P_{d_sum} is Σₙ|Dₙ|² and P_{c_sum} is |Σₙ Dₙ|², a relationship of P_{d_sum}>P_{c_sum} is established by Equation 7.

In other words, Equation 7 means that the sum of individual power of DMRS correlation signals (P_{d_sum}) is the upper limit of power (P_{c_sum}) for the sum of DMRS correlation signals. Here, when the left-hand side of Equation 7 is the same as the right-hand side of Equation 7, all of N_{D} correlation signals Dₙ (n=0, 1, . . . , N_{D}-1) are the same, which is true when the sequence of a cell is the same as the sequence of a terminal due to the characteristic of a sequence (i.e., when it is a serving cell). When it is noise or a sequence of an adjacent cell, the right-hand side is smaller than the left-hand side. When both sides are divided by N_{D}, it is shown as in Equation 8, and the left-hand side corresponds to the average power of DMRS correlation signals

$$( {P}_{d \_ avg} = \frac{{\sum }_{n} {\vert {D}_{n} \vert}^{2}}{{N}_{D}} )$$

and the right-hand side corresponds to DMRS correlation power

$$( {P}_{c \_ avg} = \frac{{\vert {\sum }_{n} {D}_{n} \vert}^{2}}{{N}_{D}} )$$

(i.e., a value obtained by dividing power for the sum of DMRS correlation signals by the number of DMRS correlation signals).

$$\frac{{\sum }_{n} {\vert {D}_{n} \vert}^{2}}{{N}_{D}} \geq \frac{{\vert {\sum }_{n} {D}_{n} \vert}^{2}}{{N}_{D}} \qquad [ Equation 8 ]$$

In the present disclosure, whether occupancy is performed is determined by comparing the above-described occupancy threshold power value (P_{th_o}) with DMRS correlation power

$$( {P}_{c \_ avg} = \frac{{\vert {\sum }_{n} {D}_{n} \vert}^{2}}{{N}_{D}} ) ,$$

not with the average power of DMRS correlation signals

$$( {P}_{d \_ avg} = \frac{{\sum }_{n} {\vert {D}_{n} \vert}^{2}}{{N}_{D}} ) .$$

In other words, instead of directly comparing the measured thermal noise power to a thermal noise threshold value (P_{th_o}), a comparison may be performed with DMRS correlation power that is guaranteed to be smaller than the measured thermal noise power, generating a margin for a comparison. The gain value of a margin is generated by the maximum number of used DMRSs. For example, when 6 DMRSs are used, it has a margin of 7.8 dB which is up to 6 times a simple power comparison method.

Hereinafter, a specific cell occupancy determination method is described.

A specific cell occupancy determination includes a method for determining whether occupancy is performed based on a cell-related identifier (i.e., a PCI) of a specific cell, in order to determine whether occupancy is performed by a target cell (i.e., a specific cell) that it wants to measure among multiple cells including a neighboring cell, for a case in which the measured DMRS correlation power exceeds an occupancy threshold value and a corresponding resource is occupied (by arbitrary cells). Alternatively, a specific cell occupancy determination may also include a method for determining whether an arbitrary resource is occupied based on the cell-related identifier (e.g., a PCI) of a specific cell without being limited to a resource occupied by arbitrary cell(s).

Generally, in a mobile communication network, a base station is composed of 2-3 cells distinguished by a cell identifier (PCI), and a cell becomes a unit that manages its own wireless resource and reuses a wireless resource. Accordingly, the same wireless resource (e.g., a RB) may be simultaneously occupied by multiple cells, and a terminal may perform a channel estimation process for demodulation through a DMRS sequence generated by using an identifier (e.g., a scrambling identifier) configured by a higher layer or a PCI. Generally, it is impossible to determine which cell occupies an occupied wireless resource through simple power detection (or energy detection).

In the present disclosure, a difference between the average power of DMRS correlation signals

$$( {P}_{d \_ avg} = \frac{{\sum }_{n} {\vert {D}_{n} \vert}^{2}}{{N}_{D}} )$$

and DMRS correlation power

$$( {P}_{c \_ avg} = \frac{{\vert {\sum }_{n} {D}_{n} \vert}^{2}}{{N}_{D}} )$$

is defined as a DMRS correlation power difference (P_{diff}=P_{d_avg}−P_{c_avg}), which may be used to determine whether occupancy is performed by a specific cell. In Equation 8, a condition that the left-hand side is the same as the right-hand side (i.e., a condition of P_{diff}=0) is a case in which a transmitted DMRS sequence is the same as a sequence on a receiving side. When a wireless resource is occupied only by a designated cell (i.e., a specific cell) or the signal of a designated cell is larger than that of an adjacent cell, i.e., when the SINR of a designated cell is large, P_{diff} approaches 0, so it may be determined to be occupied by a designated cell. When the power of an adjacent cell is greater than that of a designated cell, it has a low SINR, and in this case, it is hard to determine whether a designated cell has a signal, and in fact, it is difficult to perform demodulation due to the low SINR of a DMRS in a mobile communication terminal, so it may be determined to be unoccupied by a designated cell.

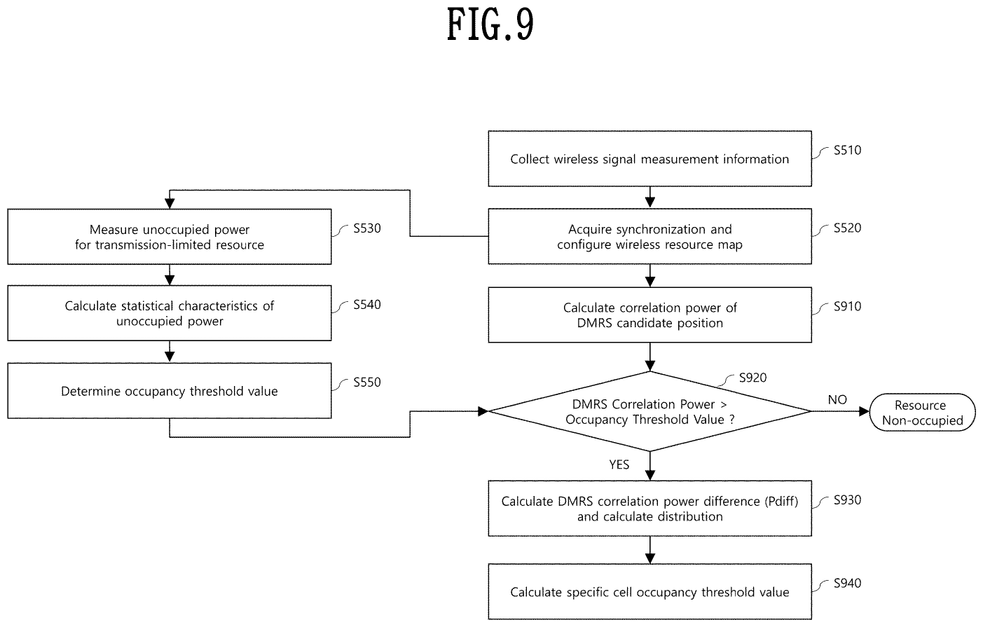

FIG. 9 is a diagram showing an example of calculating a specific cell occupancy threshold value according to the present disclosure.

In FIGS. 9, S510 to S550 are the same as those described in FIG. 5, so an overlapping description is omitted.

In S910, a device may calculate DMRS correlation power (P_{c_avg}) for a position where a DMRS may exist for each DMRS type (i.e., a DMRS candidate position) and designate the largest value among them as DMRS correlation power. In S920, a RB where a DMRS correlation power value exceeds (or is greater than or equal to) an occupancy threshold power value (P_{th_o}), i.e., an occupied RB may be distinguished. For an occupied RB (i.e., when a result of S920 is YES), a DMRS correlation power difference (P_{diff}) may be calculated and a distribution therefor may be calculated in S930, and then the value of a confidence level desired in the distribution of DMRS correlation power differences may be determined as a specific cell occupancy threshold value in S940. When a result of S920 is NO, a corresponding RB may be determined as being unoccupied.

In the present disclosure, in order to calculate the threshold value of correlation power difference P_{diff} for determining whether a specific cell is occupied, the distribution of DMRS correlation power values based on a cell-related identifier that does not clearly occupy a corresponding wireless resource may be used for a wireless resource that is determined as being occupied. As described above, when the same sequence as a transmission DMRS sequence is used, power (i.e., P_{c_sum}) for the sum of Np correlation signals as a whole is Np times larger than DMRS correlation power and when a sequence is different, it is less than N_{D} times from 0. Accordingly, DMRS correlation power is calculated by using a cell identifier that is not used by a neighboring cell, and the value of a target confidence interval (e.g., 95%) is selected from the distribution of DMRS correlation power differences (P_{diff}) and is configured as a specific cell occupancy threshold value. In other words, for a wireless resource determined to be occupied by an occupancy threshold value, a DMRS correlation power difference (P_{diff}) is calculated by using an identifier that is not allocated to a neighboring cell, a distribution therefor is generated and a specific cell occupancy threshold value is selected.

Here, when a method for searching the actually used PCI of a neighboring cell through measurement each time is used, the SSB of a neighboring cell must be continuously received and processed during measurement, and in addition, due to the characteristics of beamforming, a situation may occur where the PCI of a neighboring cell is not measured at a specific time point. Accordingly, in the present disclosure, an unused cell-related identifier (or, a ghost cell identifier (a ghost PCI)) is used as an identifier that is not allocated to a neighboring cell. For example, since the range of values of a cell identifier PCI is 0-1007 in the 5G mobile communication, it is certain that a cell identifier with a value of 1008 or higher is not used in any cell, which may be used as an unused cell-related identifier (or a ghost cell identifier).

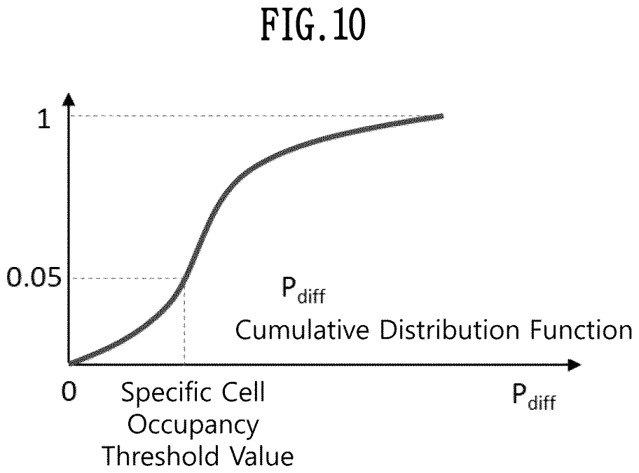

FIG. 10 is a diagram illustratively showing a 95% confidence level threshold value and a cumulative distribution function of a DMRS correlation power difference according to the present disclosure.

According to the above-described unused cell-related identifier, a DMRS correlation power difference (P_{diff}) cumulative distribution as in FIG. 10 may be calculated. For this distribution, a specific cell occupancy threshold value fit for a target confidence level (e.g., 95%) may be determined.

In the above-described examples, a resource block that is the target of determining whether occupancy is performed or determining whether a specific cell is occupied may belong to a resource block group (RBG). For example, in the 5G mobile communication, 2-16 wireless resources (e.g., RBs) of a PDSCH may be allocated in a unit called a RBG (a RB Group) in a bundle. When M RBs are included in a RBG and each RB has N_{D} DMRS sequences (i.e., when the candidate position of a DMRS is N_{D} subcarriers/REs within one RB), a DMRS sequence length may be deemed to increase by M×N_{D}, but in fact, since a channel function (hₘ, m=0, 1, . . . , M−1) is different for each RB, this may not be used as one consecutive sequence.

In the present disclosure, when a wireless resource is allocated in a unit of a RBG, the average value of P_{diff} of individual RBs within a RBG may be used to determine whether a specific cell is occupied. In other words, if a RBG is composed of M RBs, a DMRS correlation power difference for a RBG (P_{diff},G) may be calculated by

$$\frac{1}{M} {\sum }_{m} {P}_{diff , m} ( m = 0 , 1 , … , M - 1 ) .$$

Accordingly, whether a corresponding RBG is occupied by a specific cell may be determined by comparing P_{diff},G with a specific cell occupancy threshold value.

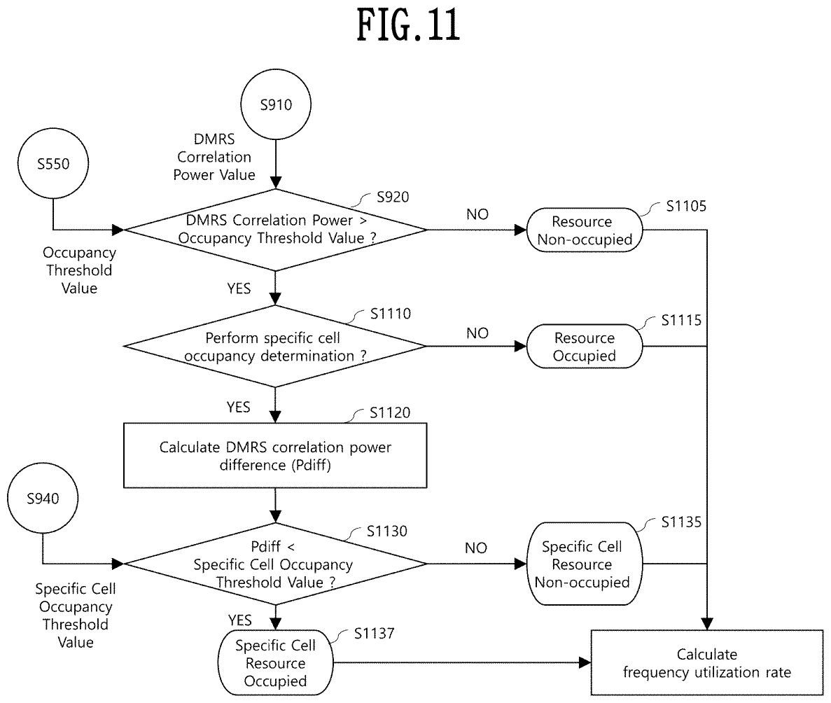

FIG. 11 is a diagram showing an example of a resource occupancy determination for measuring a frequency utilization rate according to the present disclosure.

In S920, a device may perform a comparison between a DMRS correlation power value calculated in S910 and an occupancy threshold value calculated in S550 as described in an example of FIG. 9. In S920, for a PDCCH scrambling ID used for generating a DMRS sequence, a PDSCH scrambling ID value configured by a higher layer may be applied, and when there is no scrambling ID configuration, a DMRS sequence may be generated based on a PCI. Here, a PCI may be a PCI designated by a user, or when it is not designated by a user, a PCI with the highest signal intensity (e.g., Synchronization Signal Reference Signal Received Power (SS-RSRP)) may be used.

In S920, a resource determined to be less than or equal to (or below) an occupancy threshold value may be determined as being unoccupied in S1105. In S920, for a resource exceeding (or greater than or equal to) an occupancy threshold value, whether to perform a specific cell occupancy determination may be determined in S1110. When there is no specific cell-related identifier information (e.g., a PCI) designated by a user, it may be determined that a resource is occupied by an arbitrary cell in S1115. When there is specific cell-related identifier information (e.g., a PCI) designated by a user, it may be determined to perform a specific cell occupancy determination and proceed to S1120.

In S1120, when there is a cell where measurement is designated by a user, a device may calculate a DMRS correlation power difference (P_{diff}) which is a difference between DMRS correlation power

$$( {P}_{c\_avg} = \frac{{\vert {\sum }_{n} {D}_{n} \vert}^{2}}{{N}_{D}} )$$

calculated based on the identifier of a corresponding cell (i.e., a specific cell) and the average power

$$( {P}_{d\_avg} = \frac{{\sum }_{n} {\vert {D}_{n} \vert}^{2}}{{N}_{D}} )$$

of DMRS correlation signals.

In S1130, a device may compare a specific cell occupancy threshold value calculated in S940 with a DMRS correlation power difference (P_{diff}). A resource having a value of P_{diff} greater than or equal to (or exceeding) a specific cell occupancy threshold value may be determined as a resource unoccupied by a corresponding specific cell in S1135. A resource having a value of P_{diff} below (or less than or equal to) a specific cell occupancy threshold value may be determined as a resource occupied by a corresponding specific cell in S1137.

A frequency utilization rate may be calculated/measured by synthesizing the results of determining that it is not occupied by any cell (i.e., unoccupied), it is occupied by an arbitrary cell, it is unoccupied by a specific cell and it is occupied by a specific cell in S1105, S1115, S1135 and S1137. For example, based on the ratio of resources occupied by an arbitrary cell within the entire available frequency resources, a frequency utilization rate that does not distinguish between cells may be calculated. Alternatively, based on the ratio of resources occupied by a specific cell within the entire available frequency resources, a frequency utilization rate by a specific cell may be calculated. Alternatively, based on the ratio of resources occupied by an arbitrary cell within the entire available frequency resources and resources occupied by a specific cell, a frequency utilization rate by a specific cell among the frequency resources in use may be calculated.

According to the configuration of the present disclosure, by measuring the distribution of thermal noise through measurement for a transmission-limited resource, an occupancy threshold value for a wireless resource may be calculated to determine whether a resource is occupied by an arbitrary cell. In addition, when it is determined that a wireless resource is occupied by an arbitrary cell, or independently of whether it is occupied by an arbitrary cell, whether it is occupied by a specific cell may be determined through the distribution of differences between the average power of correlation signals at a DMRS candidate position and DMRS correlation power based on the identifier of a specific cell (i.e., a DMRS correlation power difference). Through this, a frequency utilization rate in a mobile communication network may be measured accurately and efficiently.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed:

1. A method for determining a resource occupancy in a mobile communication network, the method comprising:
calculating an occupancy threshold value based on received power for a transmission-limited resource; and
based on a reference signal correlation power value for a specific resource block and the occupancy threshold value, determining whether the specific resource block is occupied.

2. The method of claim 1, wherein:
the occupancy threshold value is calculated based on a maximum thermal noise power value for the transmission-limited resource.

3. The method of claim 2, wherein:
the maximum thermal noise power value is calculated by reflecting a thermal noise variation according to an ambient temperature for a thermal noise collected for the transmission-limited resource.

4. The method of claim 1, wherein:
the transmission-limited resource corresponds to a resource excluding a synchronization signal (SS)/a primary synchronization signal (PSS) within a physical broadcast channel (PBCH) block (SSB), a secondary synchronization signal (SSS), and the PBCH.

5. The method of claim 1, wherein:
the reference signal correlation power value, for a signal received at a candidate position of the reference signal in the specific resource block, is calculated based on power of a sum of signals multiplied by a complex conjugate of the reference signal sequence.

6. The method of claim 1, wherein:
when the reference signal correlation power value for the specific resource block exceeds the occupancy threshold value, the specific resource block is determined as being occupied,
when the reference signal correlation power value for the specific resource block is less than or equal to the occupancy threshold value, the specific resource block is determined as being unoccupied.

7. The method of claim 1, wherein:
the specific resource block includes at least one physical resource block (PRB) on one orthogonal frequency division multiplexing (OFDM) symbol,
the reference signal is a demodulation reference signal (DMRS) for a physical downlink shared channel (PDSCH).

8. The method of claim 1, wherein:
based on a result of the occupancy determination for each of at least one resource block within an available frequency resource, a frequency utilization rate is calculated.

9. The method of claim 1, wherein the method further includes:
for the specific resource block determined as being occupied, calculating a specific cell occupancy threshold value based on a first reference signal correlation power difference based on an unused cell-related identifier;
for the specific resource block determined as being occupied, calculating a second reference signal correlation power difference based on a specific cell-related identifier;
based on the second reference signal correlation power difference and the specific cell occupancy threshold value, determining whether the specific resource block determined as being occupied is occupied by the specific cell; and
based on a result of determining whether each of at least one resource block within an available frequency resource is occupied by the specific cell, calculating a frequency utilization rate for the specific cell.

10. A device for determining a resource occupancy in a mobile communication network, the device comprising:
at least one transceiver;
at least one processor; and
at least one memory operably connected to the at least one processor, and storing an instruction to make the device perform an operation when executed by the at least one processor,
wherein the processor is configured to:
calculate an occupancy threshold value based on received power for a transmission-limited resource; and
based on a reference signal correlation power value for a specific resource block and the occupancy threshold value, determine whether the specific resource block is occupied.

11. A method for determining a resource occupancy by a specific cell in a mobile communication network, the method comprising:
for a specific resource block, calculating a specific cell occupancy threshold value based on a first reference signal correlation power difference based on an unused cell-related identifier;
for the specific resource block, calculating a second reference signal correlation power difference based on a specific cell-related identifier; and
based on the second reference signal correlation power difference and the specific cell occupancy threshold value, determining whether the specific resource block is occupied by the specific cell.

12. The method of claim 11, wherein:
the first reference signal correlation power difference is calculated based on a difference value between an average power value of a correlation signal of a first reference signal calculated by applying the unused cell-related identifier and a first reference signal correlation power value,
for a distribution of the first reference signal correlation power difference, the specific cell occupancy threshold value is calculated based on a confidence interval or an error rate.

13. The method of claim 11, wherein:
the second reference signal correlation power difference is calculated based on a difference value between an average power value of a correlation signal of a second reference signal calculated by applying the specific cell-related identifier and a second reference signal correlation power value.

14. The method of claim 11, wherein when the specific resource block belongs to a plurality of resource blocks of a resource block group:
a second reference signal correlation power difference for each of the plurality of resource blocks is calculated;
an average value of a plurality of second reference signal correlation power differences for the plurality of resource blocks is calculated;
based on the average value of the plurality of second reference signal correlation power differences and the specific cell occupancy threshold value, whether the resource block group is occupied by the specific cell is determined.

15. The method of claim 11, wherein:
the unused cell-related identifier has a value other than 0 to 1007.

16. The method of claim 11, wherein:
the specific cell-related identifier includes at least one of a physical cell identifier (PCI) allocated to the specific cell or a scrambling identifier allocated to the specific cell,
the PCI allocated to the specific cell has a value of one of 0 to 1007.

17. The method of claim 11, wherein:
when the second reference signal correlation power difference exceeds the specific cell occupancy threshold value, the specific resource block is determined as being unoccupied by the specific cell,
when the second reference signal correlation power difference is less than or equal to the specific cell occupancy threshold value, the specific resource block is determined as being occupied by the specific cell.

18. The method of claim 11, wherein:
based on a result of determining whether each of at least one resource block within an available frequency resource is occupied by the specific cell, a frequency utilization rate for the specific cell is calculated.

19. The method of claim 11, wherein:
the specific resource block corresponds to a resource block determined as being occupied because a reference signal correlation power value for the specific resource block exceeds an occupancy threshold value calculated based on received power for a transmission-limited resource.
